(19) United States
(12) Patent Application Publication
(10) Pub. No.: US 2004/0208689 A1
(43) Pub. Date: Oct. 21, 2004

(54) Set of plates, a plate, a coupling structure and locking means therefor

(76) Inventor: Hielke Dijkstra, EA Neede (NL)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/481,295

(22) PCT Filed: Jun. 20, 2002
(86) PCT No.: PCT/NL02/00410

(30) Foreign Application Priority Data
Jun. 21, 2001 (NL) 1018352
Aug. 6, 2001 (NL) 1018715

(51) Int. Cl. B25G 3/00

(52) U.S. Cl. 403/256

(57) ABSTRACT

The invention relates to a set of plates, such as a wall, a stand, a housing and a container, comprising: at least two plates for coupling to each other, wherein the plates are provided with longitudinal receiving and inserting coupling structures securing against transversal displacement for forming a form-fitting coupling, wherein the inserting coupling structure comprises a rod extending along a respective plate and a lock opening bounded by the rod and plate; and locking means for locking and/or biasing the coupling, wherein the locking means are received in the receiving coupling structure and engage on the rod in the lock opening, to a plate provided with receiving and/or inserting coupling structures for forming a form-fitting coupling, to locking means and a coupling structure therefor.

The present invention relates to a set of plates, to a plate, a coupling structure and to locking means for such a set of plates. This set of plates forms a universal system for coupling plates or flat elements. The system is moreover of modular structure.

A set of plates according to the invention can consist of a wall constructed from plates, a stand or a housing such as a WC-cabin, or a container. The plates of the assembly are usually at an angle to each other or can be connected mutually in line. In the case of a container, an open or closed container can be assembled using the set of plates.

The set of plates can be intended for single or multiplex use. It must nevertheless be ensured that mutual translation of the plates in the set of plates in longitudinal or transversal direction is avoided as far as possible.

The present invention has for its object to provide a set of plates, wherein a properly form-fitting coupling is realized between plates for coupling by making use oft typically receiving and inserting coupling structures. These structures do not have to extend along the whole plate or plate edge but may only be present at the position of the coupling for realizing between the plates. In particular the invention provides a new type of inserting coupling structure which meets the above stated requirements but which is moreover simple to manufacture and can be made at relatively low cost. Relatively inexpensive locking means can furthermore be applied here in the form of a locking wedge or locking bracket. It is particularly noted that it is not necessary to couple both the plates along a plate edge. The plates can moreover also comprise strips and beams with a surface or surface edge for coupling.

In respect of the above stated objective, the present invention provides a set of plates, such as a wall, a stand a housing and a container, comprising:

at least two plates for coupling to each other, wherein the plates are provided with longitudinal receiving and inserting coupling structures securing against transversal displacement for forming a formfitting coupling, wherein the inserting coupling structure comprises a rod extending along a respective plate and a lock opening bounded by the rod and plate; and locking means for locking and/or biasing the coupling, wherein the locking means are received in the receiving coupling structure and engage on the rod in the lock opening. It is recommended that the plates are coupled via one or both plate edges.

By making use in the inserting coupling structure of a rod and a lock opening partly defined thereby in the case of the coupling according to the invention, structurally simple but efficiently operating form-fitting couplings are realized according to the invention. The locking means will moreover substantially not protrude outside the coupling structure or the set of plates.

A form-fitting coupling implies that, after coupling of the plates by means of the inserting and receiving coupling, structures, there are in fact substantially no free spaces present any longer between the two structures and a good mutual transfer of forces is thereby guaranteed. A mutual transversal translation is avoided here in that the two structures are provided with co-acting complementary receiving recesses and the rod engaging therein.

The two coupling structures can be manufactured from metal, plastic, wood and combinations thereof. The two structures can further be manufactured by extrusion, folding, welding and rolling operations and optionally by means of milling operations.

The plates for use in the sets of plates can consist of wood, metal, plastic and optionally cardboard or wire mesh. Combinations hereof are possible, such as laminates. Use can further be made of a strengthened edge for coupling in combination with a more fragile central part. The locking means are embodied such that a rapid coupling and uncoupling of the plates is possible, while undesired uncoupling can be avoided.

The rod for use in the inserting coupling structure can be manufactured from any appropriate material but is particularly manufactured from metal. The rod (of any desired cross sectional shape) may extend only at the position of the coupling to be formed, or over the whole edge of a plate or over a plurality of edges while forming a closed ring between which wall material (of textile or cardboard) can optionally be stretched.

An elegant inserting coupling structure results if the rod is arranged in a profile, for instance a nose profile, formed on the respective plate edge. The profile can herein be sawn open at the position of the coupling, while the rod extends through the opening.

According to another embodiment the rod is received in a wire grid forming part of the plate. The wire grid is herein embodied such that the closing forces to be generated with the locking means are absorbed by the wire structure. According to another embodiment the rod is fixed with fixing means to the plate edge. The rod can herein extend over openings arranged in the edge of the plate and be fixed in the edge or in the plate surface by means of glueing, stapling, hook nails or the like.

The locking means are received in the plate which is provided at the position of the coupling with the receiving coupling structure. When use is made of a profile in which the receiving coupling structure is arranged, it is also recommended to receive the locking means therein or to form the locking means in a profile wall or in a strip guided translatably on the profile. In the first case it is possible to receive the locking means translatably in a carriage along a profile guide in the profile. All known locking means can be used as locking means. Recommended is a locking wedge because of the simplicity of manufacture and simple use. Locking means which can be operated comprise a catch and a locking bracket, whereby the coupling is realized by operation and the bias is applied to the coupling. In order to avoid the locking means releasing the coupling in undesired manner, it is recommended that the locking means can be secured using a securing element.

According to the preferred embodiment locking means which are simple to produce and mount can be formed from a folding strip which is optionally guided on the receiving profile.

It is recommended in the set of plates that all plates are equipped with the same receiving or inserting coupling structure. This enables the use of only one type of plate. The coupling is realized in this case by placing a coupling profile, with the complementary coupling structure, between receiving or inserting coupling structures. By making use of different coupling profiles the plates can be mutually coupled at any desired angle (thus also mutually in line). It is recommended herein that the locking means are also arranged in the coupling profile at predetermined locations. With a coupling profile it is also possible to couple, more than two, for instance 3 or 4, plates (for instances a “T”-coupling or “star”-coupling).

For mutual translating of the coupling structures or plates it can be advantageous if the receiving coupling, structure is provided with roller means for displacing the inserting coupling structure longitudinally in the receiving coupling structure.

Another aspect of the present invention relates to a plate which is provided with receiving or inserting coupling structures and optional locking means which are evidently intended to form a plate structure according to the invention. The invention also relates to the above described locking means and coupling structure per se. Mentioned and other features of the invention will be further elucidated hereinbelow on the basis of a number of embodiments, which are only given byway of example with out the invention being deemed limited thereto. Reference is made herein to the annexed drawings, in which:

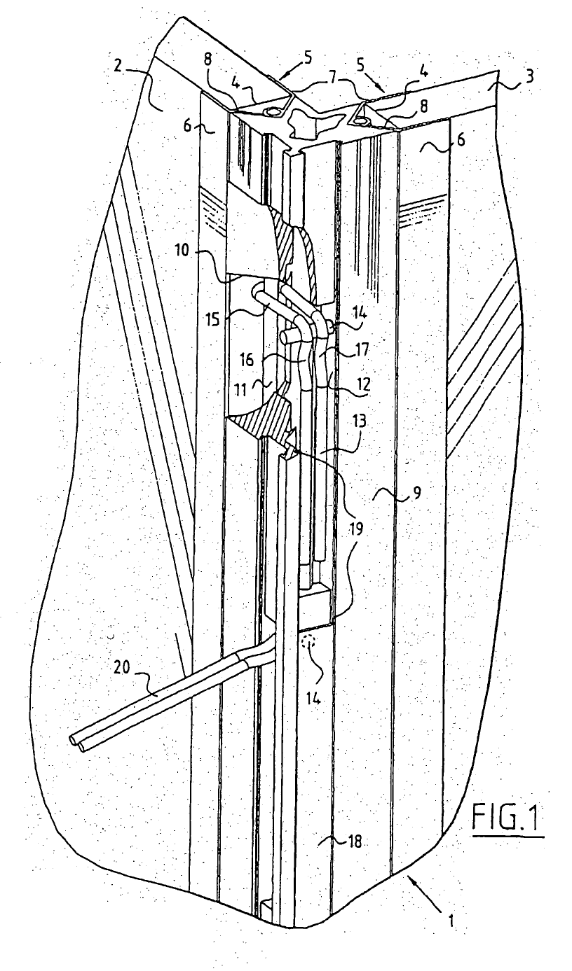

FIGS. 1, 2 and 3 each show a perspective, partly broken away view of a set of plates according to the invention;

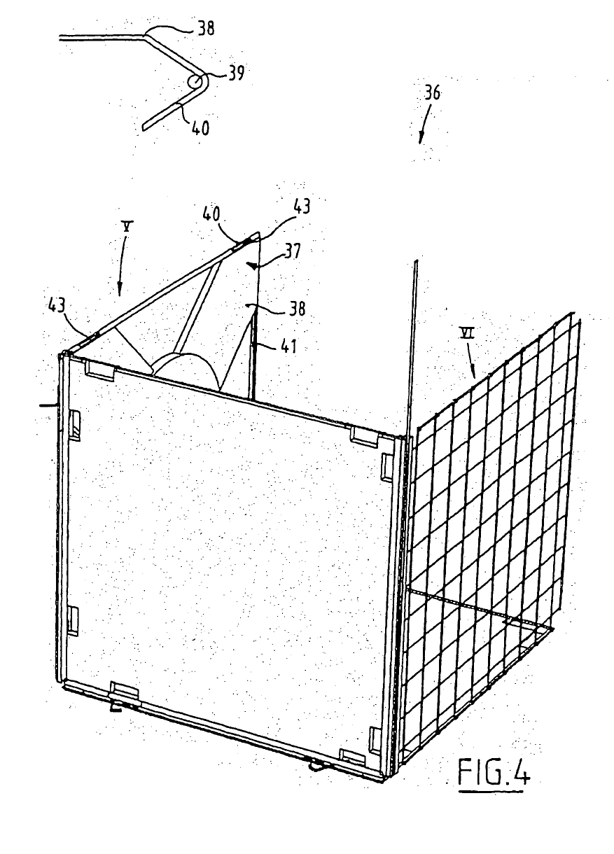

FIG. 4 shows another set of plates according to the invention;

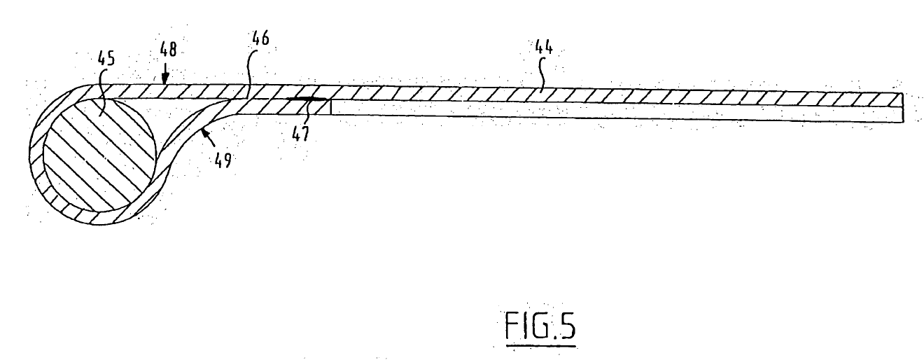

FIG. 5 shows on a larger scale detail V of FIG. 4;

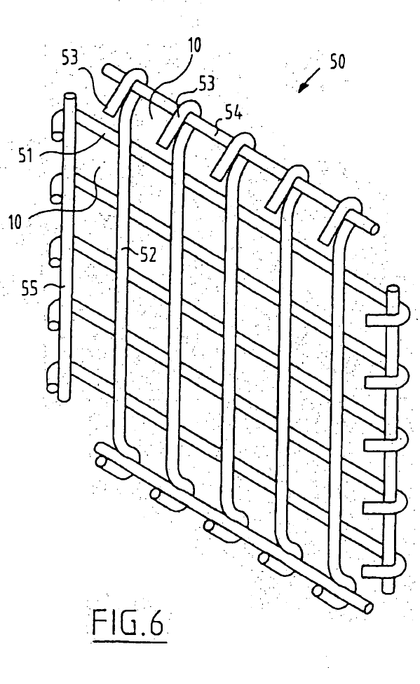

FIG. 6 shows on a larger scale detail VI of FIG. 4;

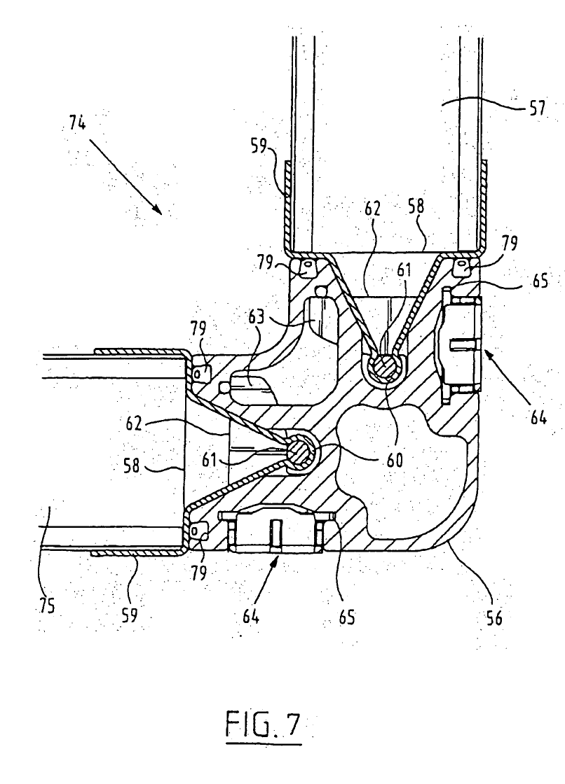

FIGS. 7-15 show views of other variants of a part of a set of plates according to the invention and

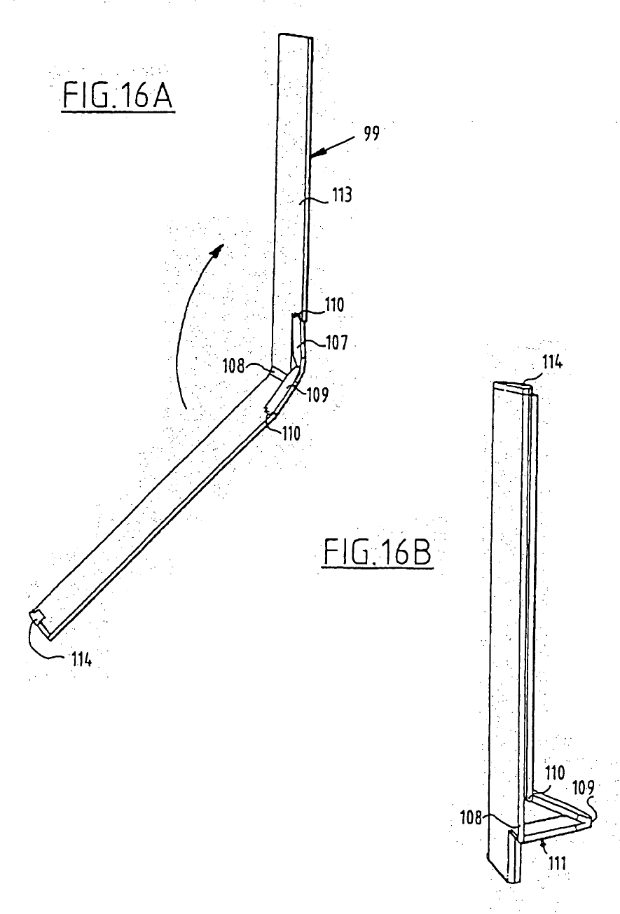

FIG. 16 shows a variant of the locking means of FIG.

FIG. 1 shows a set of plates 1 according to the invention. This set 1 comprises a plate 2 and a plate 3 which are each provided on a longitudinal edge with a nose profile 5. This nose profile 5 comprises edges 6 and 7 with which the nose, profile is fixed to plate 2 or 3. Both nose profiles form the inserting coupling structures. The receiving coupling structures are formed by the recesses 8 of a coupling profile 9 which couples plates 2 and 3 at an angle. At the position of the coupling the nose profile 5 is provided with a lock opening 10 through which extends a rod 11 of nose profile 5. Arranged in coupling profile 9 is an opening 12 through which the rod 11 can be reached. Present in this opening 12 is a locking bracket, 13 which is trained around rod 11 and tilts about a rod 14 arranged transversely in opening 12. Due to the tilting movement about rod 14 the locking bracket pulls the rod 11 tightly and locks it in coupling profile 9, and with it the nose profile 5 and the plate 2 coupled thereto.

Locking bracket 13 is formed from a metal wire and has at the position of rod 14 a constricted part 15. The distance between bracket parts 16 and 17 is thereby smaller than the thickness of rod 11, so that the chance undesired release of locking bracket 13 is reduced. After coupling the opening 12 can be closed with a closing strip 18 arranged in a guide 19 of coupling profile 9. After arranging of closing strip 16 over opening 12 the locking bracket 13 is thereby secured against release of the coupling.

Locking bracket 20 is used in similar manner to couple the plate 3 to coupling profile 9.

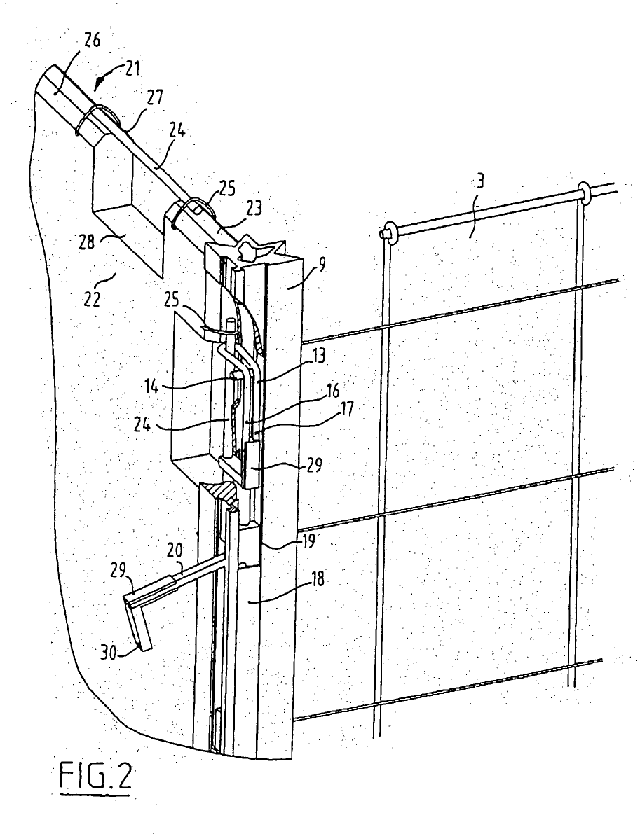

FIG. 2 shows another set of plates 21 according to the invention. A plate 22 is coupled to plate 3 via coupling profile 9. Plate 22 is provided on its longitudinal edge 23 with a rod, 24 which is fixed using a staple 25 in the side surface 26 and 27 of plate 22. Lying between staples 25 is the lock opening 28 over which the rod 24 extends. Rod 24 may extend only at the position of lock opening 28 or extend over the whole longitudinal edge of the plate. Locking bracket 13 is provided in this case on its bracket parts 16 and 17 with a securing element 29. This securing element 29 is placed on the two bracket parts 16 and 17 and snaps with an end 30 onto rod 24. Locking bracket 13 is hereby secured on rod 24. The set of plates 21 otherwise has the same features and properties as the set of plates of FIG. 1.

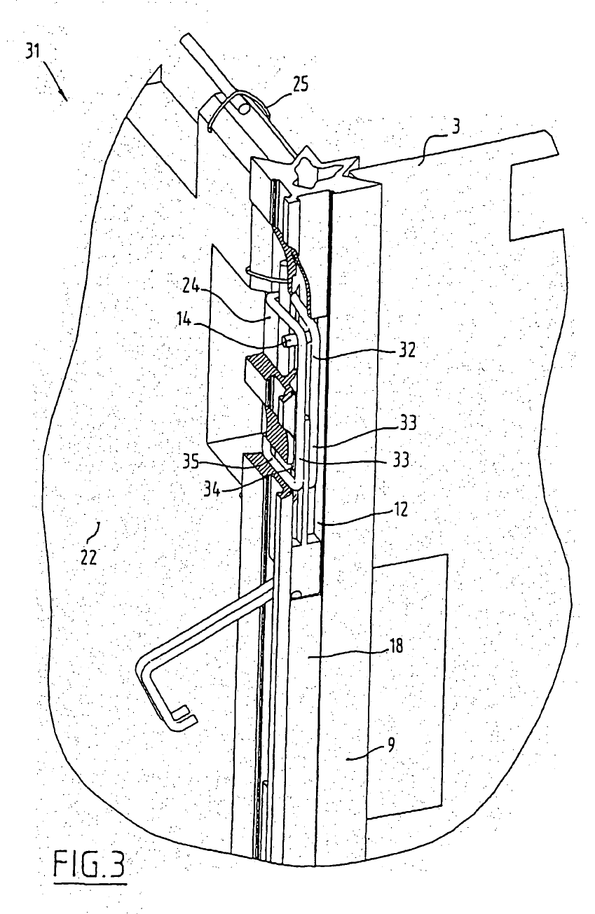

FIG. 3 shows a set of plates 31, with substantially the same structural properties as that of FIG. 1. In this case however, the locking bracket 32 is provided on both its bracket parts 33 with bent ends 34 and 35. These two ends 34 and 35 have a mutual distance which is smaller than the thickness of rod 24. After forming of the coupling these two ends 34 clamp on the rod 24 and realize a securing therewith. This securing is further ensured by placing the closing strip 18 which closes opening 12 and thereby prevents release of the coupling of plates 3 and 22 at the coupling profile 9.

After discussion of FIGS. 1-3 it is noted that although the plates are coupled via coupling profile 9 in the described sets of plates, it will be apparent to the skilled person that the plates can also be coupled to each other when the coupling profile 9 is joined to one of the two plates of the set. In the case of such a combination the coupling between coupling profile and plate is of course omitted.

FIG. 4 shows in more detail a container 36 which is assembled from different plates making use of couplings according to the invention. Container 36 comprises a container wall 37. Container wall 37 comprises a plastic plate 38 and a steel wire 39 arranged in plastic plate 38. This wire 39 is formed into a rectangular wire frame 41 and received in a V-shaped edge 40. Openings 43 are arranged at regular distances in V-shaped edge 40, whereby the lock opening 43 is created for coupling to the locking means which are arranged in an associated plate or coupling profile for coupling.

FIG. 5 shows a variant of the container wall 37. Wall 44 is embodied in the form of a frame defined by a metal wire 45 in which is spanned a wall 46 of cardboard or the like. The material is trained around wire 45 and glued together on the other side using glue 47. Although not shown in FIG. 5, an opening will be arranged at regular distances along the length of wire 45 at the position of arrows 48 and 49 in order to form the lock openings.

FIG. 6 shows another wall 50 according to the invention for a set of plates. The plate comprises wires 51 and 52 lying transversely of each other and fixedly holding the rods 54 and 55 using hooks 53. Between every two hooks 53 is formed a lock opening 10 with which the wall 50 can be coupled to an inserting coupling structure according to the invention. The biasing and coupling forces exerted by the locking means are thus absorbed by hooks 53.

FIG. 7 shows in cross-section another set of plates 74 according to the invention, wherein a plate 75 is coupled to a plate 57 via a coupling profile 56. A dust tight, soundproof or watertight connection is obtained by making use of rubber seals 79. Plate 75 and plate 57 are each provided on a plate edge 58 with a plate profile 59. This latter has a round-shaped profile nose 60 which is strengthened with a steel wire 61.

Formed in the nose of profile 59 is an opening 62 in which a wedge-shaped catch 63 of locking means 64 engages on wire 61.

Due to the wedge shape of catch 63 the plates 55 and 57 are pulled tightly onto corner profile 56. Wire 61 not only acts here as strengthening but also for a resilient bias in this coupling. Finally shown is that locking means 64 are guided translatably in a guide 65 arranged in longitudinal direction in corner profile 56.

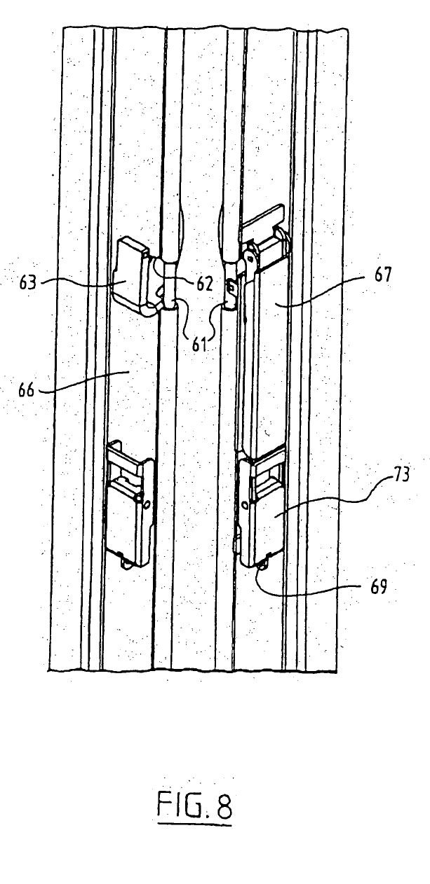

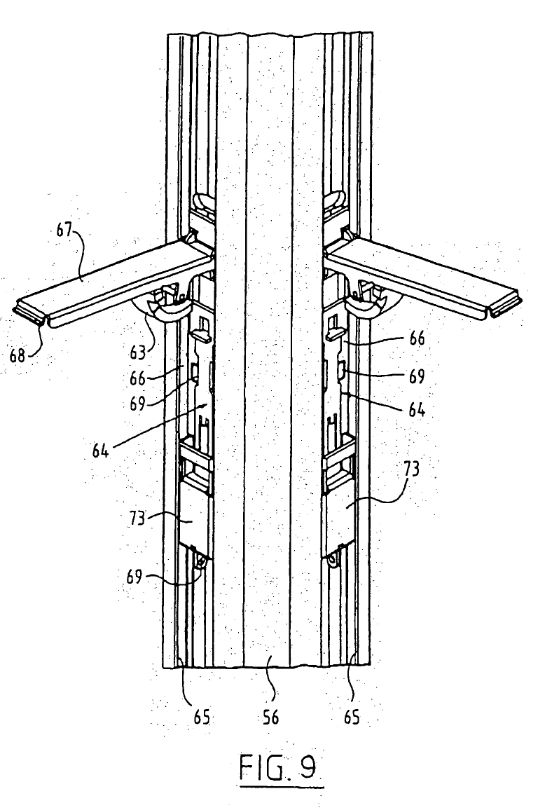

FIG. 8 (in partly cut-away state) and FIG. 9 show various aspects in side view. Locking means 64 comprise a lock carriage 66 which is guided in guide 65 and is provided with a catch 63 mounted rotatably thereon and operable with a handle 67. Handle 67 is provided with a bent edge 68, which can grip, behind a securing element 73 which is guided on carriage 66 and which is provided with an eye 69 in which securing means (not shown), for instance a lock can be mounted, whereby translation of securing element 73 is blocked. Using lips 69 for bending outward, the lock carriage 66 can be fixed in the guide.

FIG. 9 shows locking means 64 in the opened position.

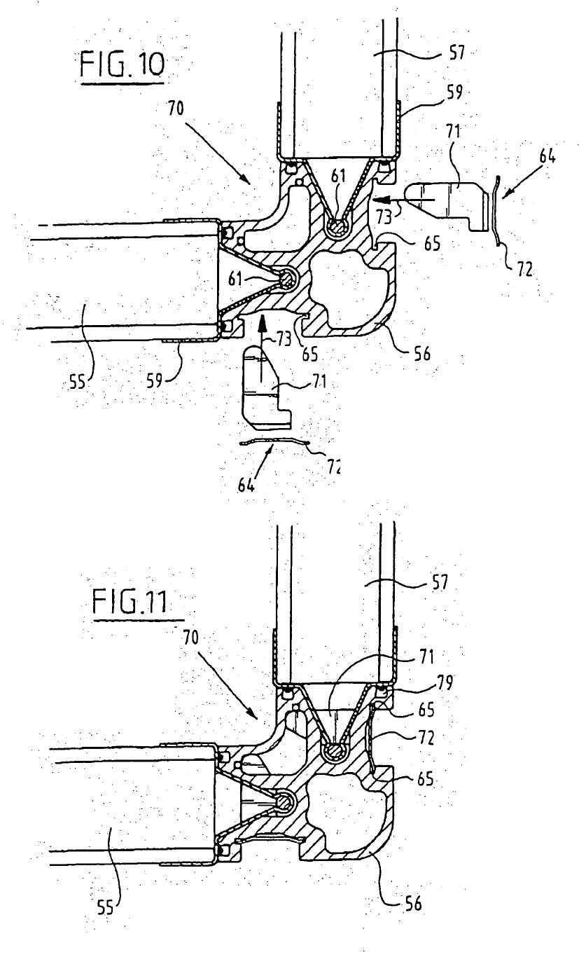

FIGS. 10 and 11 show another set of plates 70 according, to the invention. Compared to the set of plates 74 of FIGS. 7-9, locking means 64 here comprise a wedge 71 and a resilient guide strip 72. Wedge 71 engages in the wire-strengthened opening 62 through displacement in the direction of arrow 73. The situation of FIG. 11 is hereby reached in which the wedge 71 is enclosed in guide 65 through sliding of strip 72. A once again ensured coupling is hereby realized between plates 55 and 57 via corner profile 56.

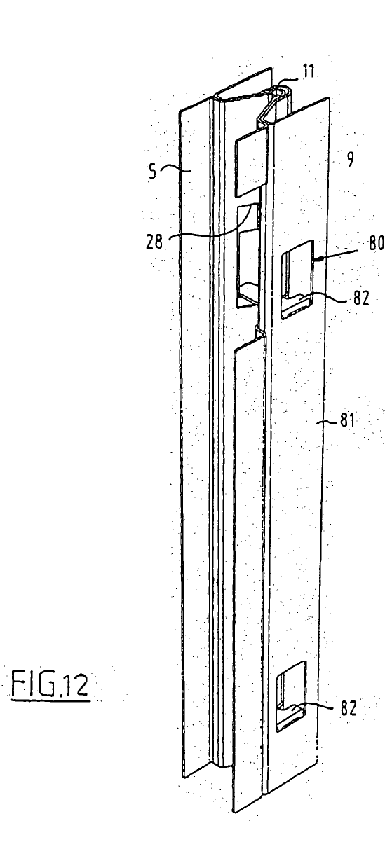

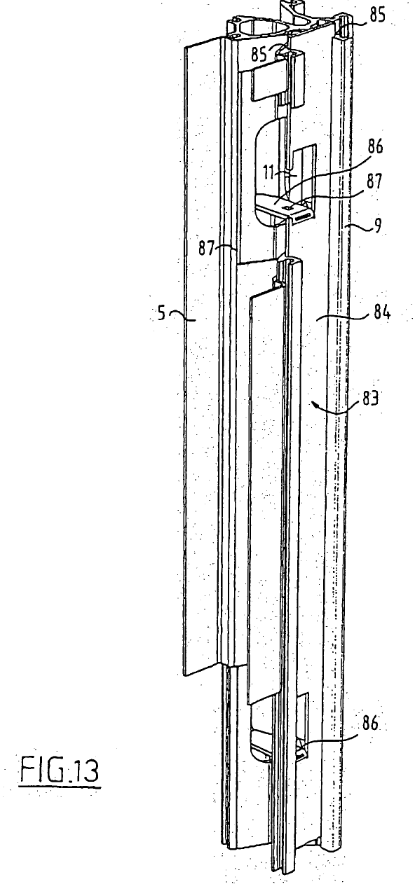

FIG. 12 shows the coupling between a nose profile 5 and a coupling profile 9. Locking means 80 are formed in this case by a lip 82 which is punched into a wall 81 of coupling profile 9 and which for securing purposes is bent and passes through and lies in a locking opening 28 arranged in nose profile 5. Thus created is a locking means which is embodied very simply but which acts with certainty.

FIG. 13 shows once again a coupling between a nose profile 5 and a coupling profile 9 in cross-sectional view at the position of the locking means. Locking means 83 are formed in this case by a strip 84 which is guided translatably in a guide 85 arranged in coupling profile 9. Strip 84 is provided with lips 86 formed therein which can be bent at the position of a locking opening 87 of nose profile 5 in order to secure both profiles 9 and 5. Each lip 86 is provided with an opening 87 which functions as an engagement point for a tool for the purpose of moving the bent lip back into the non-secured or non-closed situation.

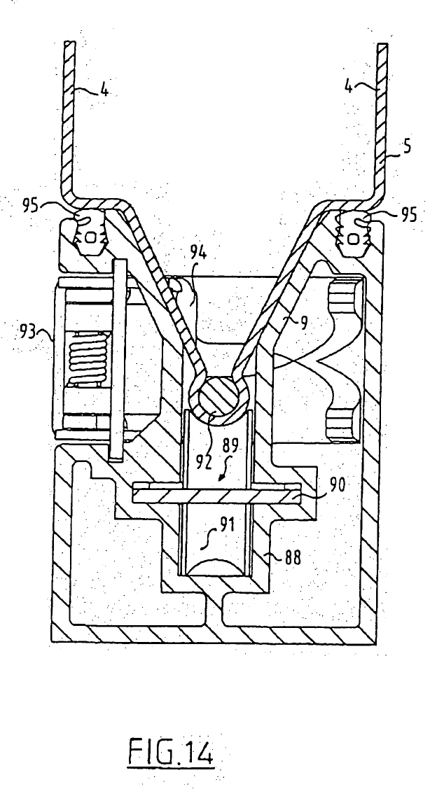

FIG. 14 shows another coupling between a nose profile 5 and a coupling profile 9. In this case the profile 5 is suitable on its longitudinal edges 4 for receiving a plate, edge. Coupling profile 9 is embodied as a tubular profile, so that the tubular profile walls or other plates can be coupled with nose profile 5. Coupling profile 9 is provided with a support 88 for roller means 89. These latter comprise a roller 91 which is arranged on a shaft 90 and which is in engagement with a nose 92 of nose profile 5. The running surface of roller 91 is manufactured from a compressible material. It is thus possible in the unsecured position for nose profile 5 to be longitudinally displaceable over roller 91 in coupling profile 9. Securing is possible in the correct position with locking means 93 which engage with a wedge 94 in an opening formed in nose profile 4. The nose is herein pulled tightly into coupling profile 9. Rubber seals 95 are compressed, as is the running surface of roller 91. Instead of compressible running surfaces, the roller shaft can also be arranged resiliently in the support 88. Roller 91 can be placed in supports 88 via shaft cavities and roller casings arranged transversely in the coupling profile.

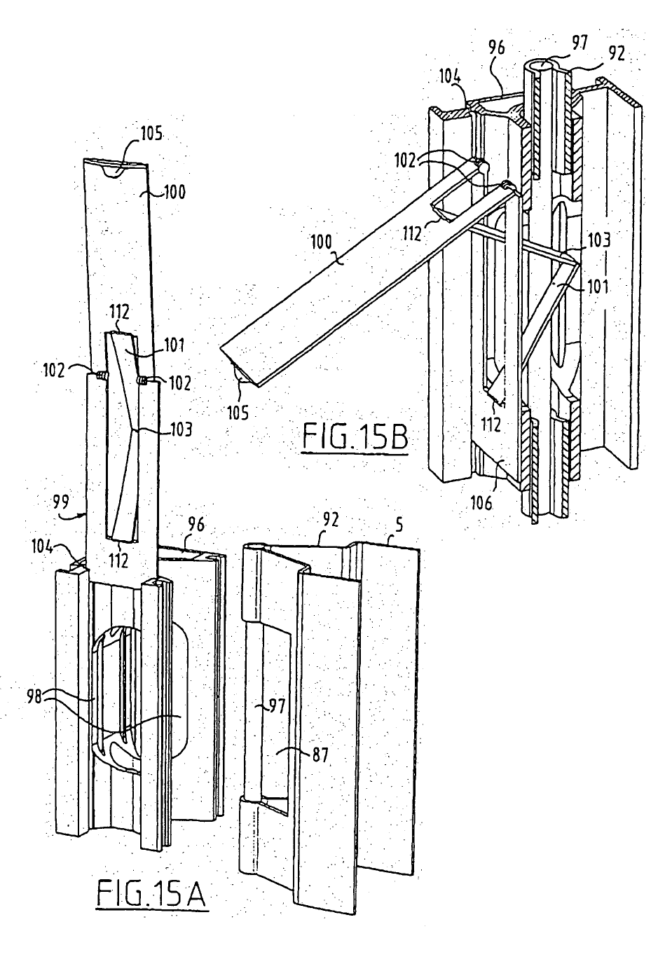

FIGS. 15A and 15B show a variant of the coupling between a nose profile 5 and a receiving profile 96. Nose profile 5 has a nose 92 and an opening 87 bounded by a wire 97. Receiving profile 96 is provided in its walls with corresponding openings 98. Present in one of the walls is a guide 104 for slidably receiving therein locking means 99 comprising blank 100. This blank has a lip 101 which can be formed by folding the blank 100 over fold-lines 102, 103 and 112. This results in the lip 101 as shown in FIG. 15B which herein extends through openings 98 and 87. The folded situation can be secured in that a securing element embodied as a catch 105 snaps behind an edge 106.

FIG. 16 shows another blank 113 comprised by the locking means 99, wherein a lip 111 can be formed by folding around fold-lines 108, 108 and 110. The blank is narrower than guide 104, so that after forming and fixing of the folded situation with a separate catch 114, the lip ill can be placed through openings 87 and 98 and can be enclosed in this situation by a visual strip or securing strip to be placed in guide 104.

It will be apparent that the profiles described according to the invention are also suitable for coupling plates on their longitudinal edges or surfaces, but also for mutually coupling plates and other structures, as shown in, among others, FIG. 14.

1. A set of plates, such as a wall, a stand, a housing and a container, comprising:
at least two plates for coupling to each other, wherein the plates are provided with longitudinal receiving and inserting coupling structures securing against transversal displacement for forming a form-fitting coupling, wherein the inserting coupling structure comprises a rod extending along a respective plate and a lock opening bounded by the rod and plate; and
locking means for locking and/or biasing the coupling, wherein the locking means are received in the receiving coupling structure and engage on the rod in the lock opening.

2. The set of plates as claimed in claim 1, wherein the rod is received in a profile, such as a nose profile, formed on the respective plate.

3. The set of plates as claimed in claim 1, wherein the rod is received in a wire grid forming part of the plate.

4. The set of plates as claimed in claim 1, wherein the rod is fixed with fixing means to a plate edge.

5. The set of plates as claimed in claim 1, wherein the locking means are received in a profile forming the receiving coupling structure.

6. The set of plates as claimed in claim 5, wherein the locking means are translatable in a carriage along a profile guide of the profile.

7. The set of plates as claimed in claim 5, wherein the locking means are formed in a profile wall.

8. The set of plates as claimed in claim 6, wherein the locking means are formed in a carriage strip.

9. The set of plates as claimed in claim 1, wherein the locking means comprise a locking wedge, a catch which can be operated with a handle, or an operable locking bracket.

10. The set of plates as claimed in claim 8, wherein the locking means can be formed from a folding strip.

11. The set of plates as claimed in claim 8, wherein the locking means can be secured using a securing element.

12. The set of plates as claimed in claim 1, wherein the plates are coupled via a coupling profile in which the receiving and/or inserting coupling structures are arranged.

13. The set of plates as claimed in claim 1, wherein the receiving coupling structure is provided with roller means for displacing the inserting coupling structure longitudinally in the receiving coupling structure.

14. A plate provided with receiving and/or inserting coupling structures for forming a form-fitting coupling for a set of plates as claimed in claim 1.

15. A locking means as claimed in claim 8.

16. A coupling structure as claimed in claim 1.
